(19) United States
(12) Patent Application Publication
(10) Pub. No.: US 2020/0386407 A1
(43) Pub. Date: Dec. 10, 2020

(54) AIRCRAFT ENGINE AND METHOD OF OPERATION THEREOF

(71) Applicant: PRATT & WHITNEY CANADA CORP., Longueuil (CA)

(72) Inventors: David MENHEERE, Norval (CA); Santo CHIAPPETTA, Georgetown (CA); Timothy REDFORD, Campbellville (CA); Daniel VAN DEN ENDE, Mississauga (CA)

(21) Appl. No.: 16/719,352

(22) Filed: Dec. 18, 2019

Related U.S. Application Data
(63) Continuation of application No. 16/433,664, filed on Jun. 6, 2019.

(51) Int. Cl. F23R 3/42; F02C 3/04; F02C 7/36

(52) U.S. Cl. CPC F23R 3/42; F02C 3/04; F05D 2220/323; F05D 2220/36; F02C 7/36

(57) ABSTRACT

The gas turbine engine can have a core gas path extending sequentially across a core compressor, a core combustor, and a core turbine, an auxiliary air intake path and a bypass intake path leading in parallel to the core compressor, an auxiliary compressor in the auxiliary air intake path, an auxiliary gas path downstream of the core compressor, the auxiliary gas path extending in sequence across an auxiliary combustor and an auxiliary turbine, in parallel with the core combustor and core turbine, and valves operable to control the flow through the bypass gas path and the auxiliary gas path. Accordingly, the auxiliary components can be operated to increase power output, or deactivated while allowing the core components to run efficiently while meeting a lower power output.

### CROSS-REFERENCE TO RELATED APPLICATIONS

This application claims priority of U.S. application Ser. No. 16/433,664 filed Jun. 6, 2019, the entire contents of which are incorporated by reference herein.

### TECHNICAL FIELD

The application related generally to gas turbine engines and, more particularly, to gas path configurations thereof.

### BACKGROUND OF THE ART

Aircraft turbine engines operate at a variety of design points, including takeoff and cruise, and are also designed in a manner to handle off-design conditions. Some aircraft can have large power differences between operating points, such as between takeoff and cruise for instance, which can pose a challenge when attempting to design an engine which is fuel efficient. Indeed, some aircraft engines are over-designed when viewed from the cruise standpoint, to be capable of handling takeoff power, which can result in operating the engine during cruise in a less than optimal regime from the standpoint of efficiency. It could be easier, based on the power requirements, to use two smaller engines at takeoff power and revert to a single powered engine in cruise. However, such a second engine may add weight, complexity, can reduce the reliability of the overall package, and can introduce subsequent challenges such as cold engine start times and one engine inoperative (OEI) requirements, if one engine is turned off in cruise flight. Accordingly, there remained room for improvement.

### SUMMARY

In one aspect, there is provided a gas turbine engine having a core gas path extending sequentially across a core compressor, a core combustor, and a core turbine, an auxiliary air intake path and a bypass intake path leading in parallel to the core compressor, an auxiliary compressor in the auxiliary air intake path, an auxiliary gas path downstream of the core compressor, the auxiliary gas path extending in sequence across an auxiliary combustor and an auxiliary turbine; in parallel with the core combustor and core turbine, and valves operable to control the flow through the bypass gas path and the auxiliary gas path. The gas turbine engine can be an aircraft engine.

In another aspect, there is provided a method of operating an aircraft engine comprising while continuously operating an engine core of the aircraft engine, including conveying air across a core compressor, a core combustor and a core turbine, decreasing a flow rate of compressed air bled between the core compressor and the core combustor to feed an auxiliary combustor and an auxiliary turbine, the auxiliary turbine driving an auxiliary compressor upstream of the core compressor, in turn decreasing a pressure upstream of the core compressor and decreasing a power output of the aircraft engine.

### DESCRIPTION OF THE DRAWINGS

Reference is now made to the accompanying figures in which:

FIG. 1 is a schematic cross-sectional view of a gas turbine engine;

FIGS. 2A and 2B are schematic cross-sectional views of a gas turbine showing two different modes of operation; and

FIG. 3 is a schematic cross-sectional view of a turboprop gas turbine engine.

### DETAILED DESCRIPTION

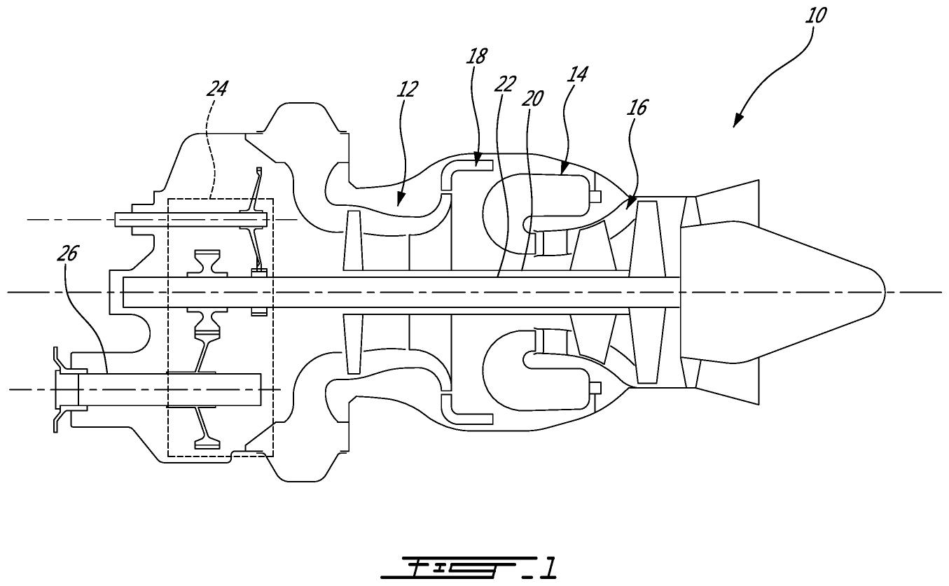

FIG. 1 illustrates an example of a turbine engine. In this example, the turbine engine 10 is a turboshaft engine generally comprising in serial flow communication, a multistage compressor 12 for pressurizing the air, a combustor 14 in which the compressed air is mixed with fuel and ignited for generating an annular stream of hot combustion gases, and a turbine section 16 for extracting energy from the combustion gases. The turbine engine terminates in an exhaust section.

The fluid path extending sequentially across the compressor 12, the combustor 14 and the turbine 16 can be referred to as the core gas path 18. In practice, the combustor 14 can include a plurality of identical, circumferentially interspaced, combustor units. In the embodiment shown in FIG. 1, the turboshaft engine 10 has two compressor and turbine stages, including a high pressure stage associated to a high pressure shaft 20, and a low pressure stage associated to a low pressure shaft 22. The low pressure shaft 22 is used as a power source during use, and the low pressure turbine can thus be referred to as a power turbine.

Turboshaft engines, similarly to turboprop engines, typically have some form of gearing by which the power of the low pressure shaft 22 is transferred to a load. The load can be an external shaft 26 bearing the blades or propeller, or an electric generator for instance. Some turbofan designs can also have some form of gearing via which power is transferred to a shaft bearing a fan, such as an aft fan arrangement for instance. Gearing, which can be referred to as a gearbox 24 for the sake of simplicity, typically reduces the rotation speed to reach an external rotation speed which is better adapted to a rotation speed of the load.

Some applications, such as helicopters to name one example, can have large power differences between Take-Off (TO) and cruise. In some embodiments, a further power requirement can exist, such as a 30 second one-engine inoperable (OEI) power requirement for instance, which can be even higher than the Take-off power requirement. A typical helicopter can require less than 50% power to cruise versus its highest power rating. Since an engine can be significantly more fuel efficient at its design power, designing the engine to the take-off power level, or to the OEI power level, for instance, can result in the engine running in off-design condition for the majority of its mission, leaving a want for better fuel efficiency.

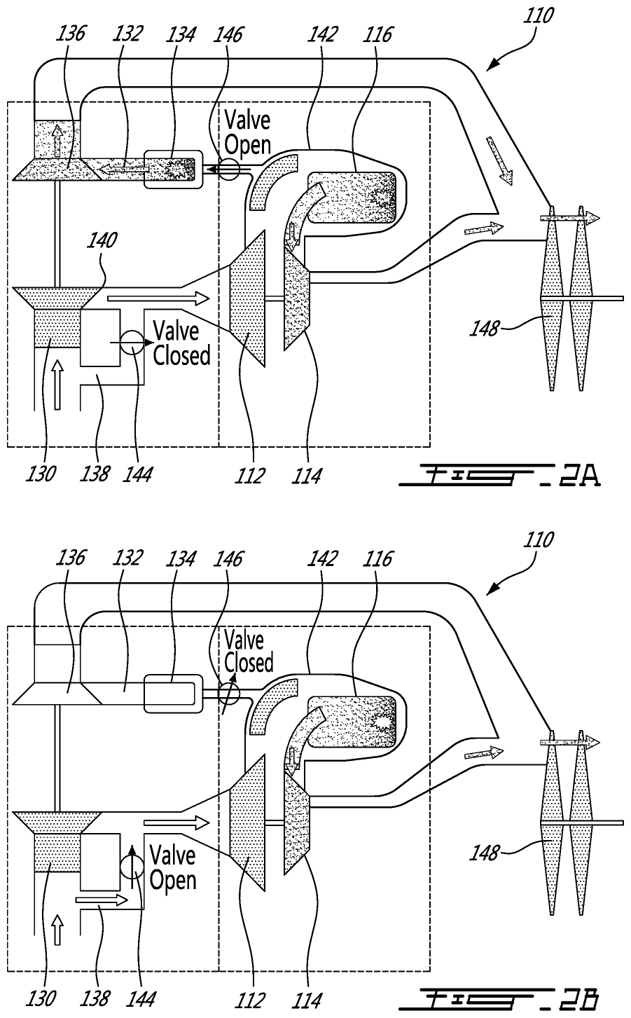

FIGS. 2A and 2B show an example of an aircraft engine 110 which has an engine core having a core compressor 112, a core combustor 114, and a core turbine 116, In this embodiment, the aircraft engine 110 further has an optionally operable auxiliary compressor 130 upstream of the core compressor 112, and an optionally operable auxiliary gas path 132 having an auxiliary combustor 134 fluidly leading to an auxiliary turbine 136. The auxiliary combustor 134 and auxiliary turbine 132 extend in parallel with the core combustor 116 and core turbine 114, whereas a bypass path 138 is provided in parallel with the auxiliary air intake path 140. The auxiliary gas path 132 is configured to receive compressed air from the core gas path 142, more specifically bled from a point located between the core compressor 112 and the core combustor 114.

Valves are provided in a manner to allow selectively operating the auxiliary components to achieve a higher level of power, such as takeoff power for instance, which is illustrated in FIG. 2A, or to segregate the auxiliary components from the core components and operate only the core components to reach a lower level of power, such as cruise power for instance, in a fuel efficient manner, such as illustrated in FIG. 2B. The valves can include a bypass valve 144 in the bypass intake path 138 and an auxiliary valve 146 upstream of the auxiliary turbine 136 in the auxiliary gas path 132. The bypass valve 144 can be a simple check valve operable to prevent reverse flow through the bypass path 138, whereas the auxiliary valve 146 can be modulatable to intermediary positions between a fully open state and a fully closed state, or simply switchable between the fully open state and fully closed states.

The auxiliary compressor 130 can be driven by the auxiliary turbine 136 and be operable to increase the pressure upstream of the core compressor 112 to increase power output. Moreover, a power turbine 148 can be provided to receive the gas outputted by the core turbine 114 and generate power corresponding to the power output of the aircraft engine 110. In this embodiment, the gas outputted by the auxiliary turbine 136 is recombined and also fed through the power turbine 148, when the auxiliary combustor 134 is in operation, in an effort to preserve energy where available. The power turbine 148 can be drivingly connected to a load, such as via a gearbox, for instance.

Accordingly, in one example, the core and the auxiliary components can be operated simultaneously to provide a high power output such as takeoff power, and the mode of operation can then be transitioned to a cruise mode. In this transition, while continuously operating the engine core of the aircraft engine 110, the flow rate of compressed air bled from the core gas path 142 to feed the auxiliary combustor 134 and turbine 136 is decreased, decreasing the power harnessed by the auxiliary turbine 136 and, in turn decreasing the compressive power of the auxiliary compressor 130, and the pressure upstream of the core compressor 112. This will lead to a decreased power output of the aircraft engine 110. During this process, flow reversal through the bypass path 138 can be prevented by the bypass valve 144 which can be any suitable valve. A check valve can be preferred as it can perhaps more naturally allow a portion of the intake flow to bypass the auxiliary compressor 130 when the pressure conditions are met. In one embodiment, the engine 110 can be operated with partial auxiliary power for a given amount of time, such as by feeding a partial flow rate of fuel and/or a partial flow rate of bleed air to the auxiliary combustor. In another embodiment, it can be preferred to transition directly from the fully open state to the fully closed state of the auxiliary valve and to fully cease fuel supply to the auxiliary combustor. This can involve actively transitioning the bypass valve from the fully closed state to the fully open state, or, if a check valve is used, this latter transition can occur passively as opposed to actively.

Compared to an approach of using two engines, the configuration presented in FIGS. 2A and 2B can allow significant simplification. For instance, while the core engine may require an engine starter, typically provided in the form of an electric motor coupled to the shaft mechanically connecting the core compressor 112 to the core turbine 114, the auxiliary components will typically have a pressurized air source readily available from the core gas path 142 between the core compressor 112 and the core combustor 116, and may therefore be provided without an engine starter in some embodiments. It can also be possible to use a significantly simpler design to the auxiliary combustor 134 than to the core combustor 116. Indeed, low gas flow conditions and cold start conditions are typically challenging situations for a combustor, and the core combustor 116 may be provided with additional complexity, such as an increased amount of fuel injectors, primary injectors used specifically for starting, and/or a more complex flow configuration. In some embodiments, the auxiliary combustor can be provided with significantly more simplicity, and thus be less expensive either in terms of initial costs or in terms of maintenance (relatively to its power), than the core combustor.

Accordingly, it is possible to size the engine core in a manner to target fuel efficiency at the cruise power level while the auxiliary components are inoperative, and to size the auxiliary components in a manner to allow achieving the maximum power requirements when they are in operation with the components of the engine core.

When the auxiliary components are inoperative, the auxiliary compressor 130 and the auxiliary turbine 136 can eventually stop turning as their rotation is slowed by the presence of gas, in a context where they are mechanically decoupled from both the core engine components and the power turbine 148. In any event, any power losses due to aerodynamic friction with environing fluid may be less relevant to consider in a scenario where the auxiliary components are not used to produce useful work. Indeed, eventual power losses stemming from the idling of the auxiliary compressor 130 and turbine 136 can be rendered irrelevant in a context where a bypass intake path 138 exists allowing to feed intake air directly to the core compressor 112 when the auxiliary components are not in operation, bypassing the auxiliary compressor 130 and any energy loss effect it otherwise may have had.

It will be noted that the selective deactivation of the auxiliary components can be performed without negatively affecting the operation of the engine core. Accordingly, during a typical flight, the same engine can be operated in two or more operating modes which can produce a significantly different power level while always operating at a relatively high level of efficiency, and without requiring an additional engine altogether. It will also be noted that the two different power levels can be achieved without a significant change of rotation speed of the turbine shaft, for instance.

In the context of a helicopter, for instance, it can be desired for the rotation speed of the power turbine's shaft not to vary too much between the different power levels. The rotation speed of the turbine at the takeoff power level can be less than 140% of the rotation speed of the power turbine at the cruise power level, for instance, possibly less than 130% (e.g. for turboprop), possibly less than 110% (e.g. for turboshaft), and even possibly less than 105%. This while the amount of power generated at the cruise power level can be less than ¾ of the amount of power generated at the takeoff power level, possibly less than ⅔^{rd}, and even possibly less than %. In some embodiments, the auxiliary combustor can be at least 10% smaller than the core combustor. In some embodiments, the auxiliary combustor can be at least 20% smaller than the first combustor.

The effect of the boost pressure on the engine can have the effect of increasing the power output in direct relation to the pressure ratio. Accordingly, doubling the power output of the engine can be accomplished by doubling the boost pressure entering the core. A configuration where the power shaft is deposed and separate from the core shaft, with the boost compressor isolated, can avoid scenarios where a shaft has to extend within another shaft, which are less desired because of potential dynamic instability. In an example where the OEI power level is higher than the takeoff power level, an aircraft engine can be designed in a manner for the OEI power level to be reachable by operating the core gas path via the auxiliary components at full power, for instance.

In one embodiment, an optional heat exchanger or recuperator can be used between the core compressor and the auxiliary compressor.

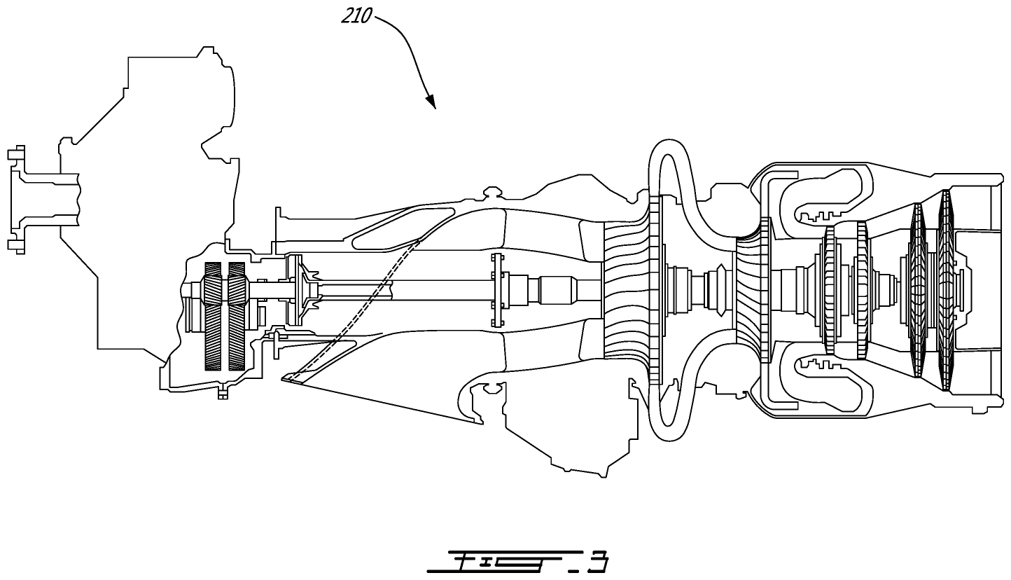

The above description is meant to be exemplary only, and one skilled in the art will recognize that changes may be made to the embodiments described without departing from the scope of the present technology disclosed. Indeed, various modifications and adaptations are possible in alternate embodiments. The bypass intake path and auxiliary air intake path can be referred to being distinct paths, and a gas path portions referred to as plenums can be used in different modes of operation. In an embodiment presented above, the auxiliary air intake path and the bypass air intake path share a common air intake. In alternate embodiments, the auxiliary air intake path and the bypass air intake path can have respective, independent air intakes, and each air intake can include one or more air breathing aperture. In the embodiment shown, the power turbine is used to drive the load, and is distinct from the core turbine. In alternate embodiments, the power turbine can be drivingly connected to the core turbine, or positioned between the combustor and the core turbine, and a different arrangement or core turbine and/or power turbine can be used to drive the core compressor, and/or load. The embodiments described herein can be applied to different engine architectures. FIG. 3, for instance, illustrates a turboprop 210 adapted to drive a propeller, and which may be modified based on the teachings presented above in a manner to incorporate a selectively useable auxiliary components. Still other modifications which fall within the scope of the present technology will be apparent to those skilled in the art, in light of a review of this disclosure.

1. A gas turbine engine comprising
a core gas path extending sequentially across a core compressor, a core combustor, and a core turbine;
an auxiliary air intake path and a bypass intake path leading to an air inlet of the core compressor;
an auxiliary compressor in the auxiliary air intake path;
a bypass air intake path having an outlet fluidly connected to the auxiliary air intake path at a location that is downstream of an outlet of the auxiliary compressor and upstream of the air inlet of the core compressor;
an auxiliary gas path downstream of and in fluid communication with an outlet of the core compressor, the auxiliary gas path extending in sequence across an auxiliary combustor and an auxiliary turbine, the auxiliary gas path being flow-wise in parallel with the core combustor and core turbine;
an auxiliary valve in the auxiliary gas path operable to control flow through the auxiliary gas path; and
a bypass valve in the bypass air intake path operable to control flow through the bypass air intake path.

2. The gas turbine engine of claim 1 wherein the auxiliary turbine is drivingly connected to the auxiliary compressor.

3. The gas turbine engine of claim 1 wherein the auxiliary valve is upstream of the auxiliary turbine, wherein the bypass valve is operable to prevent reverse flow through the bypass path.

4. The gas turbine engine of claim 3 wherein the auxiliary valve is modulatable between a fully open state and a fully closed state.

5. The gas turbine engine of claim 1 wherein a fluid output of the core turbine leads to a fluid inlet of a power turbine.

6. The gas turbine engine of claim 5 wherein the power turbine is drivingly connected to a gearbox.

7. The gas turbine engine of claim 5 wherein a fluid output of the auxiliary turbine also leads to a fluid inlet of the power turbine.

8. The gas turbine engine of claim 2 wherein a shaft of the core compressor is drivingly connected to an electric starter, whereas a shaft of the auxiliary compressor is not drivingly connected to an electric starter.

9. The gas turbine engine of claim 1 wherein the auxiliary combustor is provided with fewer fuel injectors than the core combustor.

10. The gas turbine engine of claim 1 wherein the core combustor has a more complicated airflow configuration than an airflow configuration of the auxiliary combustor.

11. The gas turbine engine of claim 6 wherein the aircraft engine is a turboshaft engine, further comprising helicopter blades mounted to a power shaft, the power shaft drivingly connected to the gearbox.

12. The gas turbine engine of claim 6 wherein the aircraft engine is a turboprop engine, further comprising a propeller mounted to a power shaft, the power shaft being drivingly connected to the gearbox.

13. A method of operating an aircraft engine comprising
operating an engine core of the aircraft engine, the operating the engine core including:
conveying air across a core flow path that includes in sequence core compressor, a core combustor and a core turbine, and
bleeding air from the core flow path at a location that is fluidly between the core compressor and the core combustor to an auxiliary combustor and an auxiliary turbine, the auxiliary turbine driving an auxiliary compressor, the auxiliary compressor having an air outlet upstream of and fluidly connected to an air inlet of the core compressor; and
during the operating the engine core, decreasing a flow rate of the air being bled from the location in the core flow path to the auxiliary combustor and the auxiliary turbine, the decreasing the flow rate in turn decreasing a pressure upstream of the air inlet of the core compressor and decreasing a power output of the aircraft engine.

14. The method of claim 13 wherein said decreasing the flow rate includes partially closing a valve leading to the auxiliary turbine from a fully open state while preventing flow reversal in a bypass intake path parallel to the auxiliary compressor.

15. The method of claim 13 wherein said decreasing the flow rate includes cutting a supply of fuel to the auxiliary combustor and closing a valve leading to the auxiliary turbine to a fully closed state while allowing intake air to bypass the auxiliary compressor to reach the core compressor.

16. The method of claim 15 wherein said decreasing the flow rate includes decreasing a power output of the aircraft engine from a takeoff power level to a cruise power level.

17. The method of claim 13 further comprising driving a power turbine using gas outputted from the core turbine, the power output of the aircraft engine corresponding to a power output of the power turbine.

18. The method of claim 17 further comprising driving the power turbine further using gas outputted from the auxiliary turbine.

19. The method of claim 17 wherein said decreasing the flow rate includes decreasing a power output of the aircraft engine from a takeoff power level to a cruise power level, wherein a rotation speed of the power turbine at the takeoff power level is less than 120% of a rotation speed of the power turbine at the cruise power level.

20. The method of claim 13 wherein the power level is decreased by at least 25%.
